(19) United States
(12) Patent Application Publication
(10) Pub. No.: US 2008/0284329 A1
(43) Pub. Date: Nov. 20, 2008

(54) Led with Improve Light Emittance Profile

(75) Inventors: Dietrich Bertram, Aachen (DE); Thomas Justel, Witten (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,438

(22) PCT Filed: Jun. 10, 2005
(86) PCT No.: PCT/IB05/51926

§ 371 Date: Dec. 12, 2006

(30) Foreign Application Priority Data
Jun. 18, 2004 (EP) 04102793.9

(51) Int. Cl. H01J 1/62; H01J 9/02; B05D 5/06

(52) U.S. Cl. 313/506; 445/50; 427/64

(57) ABSTRACT

The present invention relates to a LED comprising at least one red light emitting and/or conversion layer, which emits light in the wavelength of ≧550 nm to ≦750 nm, preferably ≧630 nm to ≦700 nm, and/or at least one blue light emitting layer, which emits light in the wavelength of ≧400 nm to ≦550 nm, preferably ≧420 nm to ≦500 nm, and/or at least one green and/or yellow emitting luminescence material, which emits light in the wavelength ≧530 nm to ≦610 nm, whereby the at least one green and/or yellow emitting luminescence material is capable of absorbing light which is emitted by the at least one blue light emitting layer, characterized in that the red light emitting and/or conversion layer is made of a semiconductor material.

This invention relates to the field of LED's. A LED is a semiconductor device that can produce an emission in a brilliant color highly efficient in spite of its very small size. Furthermore the emission produced by an LED has an excellent monochromatic peak. However, it is still a problem to produce white light by LED's. In order to obtain white light by LEDs, various techniques have been discussed. Usually, in order to produce white light by diffusing and combining the emissions of multiple LEDs, a color mixing process is needed. For example, three LEDs, each producing an emission at a wavelength in the red, green or blue range of the visible spectrum (which will be herein called red, green and blue LEDs, respectively), can be placed closely to each other. However, each of these LEDs has an excellent monochromatic peak. Accordingly, the white light produced by mixing these colors with each other is often uneven. i.e. that the color point of the white light does not fall on the black body line or the white light does not represent a spectral distribution that can is equivalent to black body radiation.

That is to say, where the emissions in the three primary colors cannot be combined together in a desired manner, the resultant white light will be uneven. To eliminate this problem of color unevenness, a technique of producing white light by using a blue LED and a yellow emitting phosphor in combination was developed e.g. as disclosed in the EP1160883 and prior art cited therein

However, all the LED's as presented in the prior art were unable to produce a white light which is even. Therefore there is an object of the present invention to provide for a LED which has an improved white light performance.

This object is achieved by a LED as taught by Claim 1 of the present invention. Accordingly, a LED is provided, comprising at least one red light emitting and/or conversion layer, which emits light in the wavelength of ≧550 nm to ≦750 nm, preferably ≧630 nm to ≦700 nm, and/or at least one blue light emitting layer, which emits light in the wavelength of ≧400 nm to ≦550 nm, preferably ≧420 nm to ≦500 nm, and/or at least one green and/or yellow emitting luminescence material, which emits light in the wavelength of ≧530 nm to ≦610 nm, whereby the at least one green and/or yellow emitting luminescence material is capable of absorbing light which is emitted by the at least one blue light emitting layer, characterized in that the red light emitting and/or conversion layer is made of a semiconductor material.

Preferably the at least one red light emitting and/or conversion layer emits light in the wavelength of ≧630 nm to ≦700 nm, preferably the at least one blue light emitting layer emits light in the wavelength of ≧420 nm to ≦500 nm, preferably the at least one green and/or yellow emitting luminescence material emits light in the wavelength of ≧540 nm to ≦600 nm, most preferred of ≧545 to ≦595 nm

The inventors have studied the problem of “unevenness” and found out that it is advantageous to use a semiconductor material as red light emitting and/or conversion layer. By doing so, especially the quality of the emitted light in the “red range” of the LED is improved.

The term “semiconductor material” according to the present invention means in particular that the material can be deposited as a film structure, and/or has a bandgap according to the above specified range of emission or larger; and/or has high photoluminescence quantum efficiency, i.e. over ≧50% and ≦100%, more preferably ≧60%, most preferred ≧70%.

The material can consist of multiple atoms as well encompass doped materials, where the emission is not restricted to band to band transition, including embedded nanostructures or color centres.

According to a preferred embodiment of the present invention, the at least one red light emitting and/or conversion layer is capable of absorbing light which is emitted by the at least one blue light emitting layer. By doing so, a better spectrum of the LED may be obtained.

According to a preferred embodiment of the present invention, the red light emitting and/or conversion layer is selected from a group comprising AlₓIn_{y}Ga_{z}P (x+y+z=1), AlₓGa₁₋ₓP (x≧ and ≦1), AlₓGa₁₋ₓAs_{y}P_{1-y} (x≧0 and ≦1; y≧0 and ≦1), AlₓGa_{y}In_{z}AsᵤP₁₋ᵤ(x+y+z=1; u≧0 and ≦1) or mixtures thereof; and/or the blue light emitting layer is selected from a group comprising AlₓIn_{y}Ga_{z}P (x+y+z=1), AlₓGa₁₋ₓP (x≧0 and ≦1), AlₓGa₁₋ₓAs_{y}P_{1-y} (x≧0 and ≦1; y≧0 and ≦1), AlₓGa_{y}In_{z}AsᵤP₁₋ₐ (x+y+z=1; u≧0 and ≦1) or mixtures thereof; and/or the green and/or yellow light emitting luminescent material is selected from a group comprising BaₓSr₁₋ₓGa₂S₄:Eu (x≧0 and ≦1), BaₓSr₁₋ₓSiO₄:Eu (x≧0 and ≦1), SrSi₂N₂O₂:Eu (x≧0 and ≦1), (YₓGd₁₋ₓ)₃(Al_{1-y}Ga_{y})₅O₁₂:Ce (x≧0 and ≦1; y≧0 and ≦1), (YₓGd₁₋ₓ)₃(Al_{1-y}Ga_{y})₅O₁₂:Ce:Ce,Pr (x≧0 and ≧1; y≧0 and ≦1) or mixtures thereof.

In case doped compounds are used for or within the red light emitting and/or conversion layer, the blue light emitting and/or conversion layer and/ or the green and/or yellow light emitting luminescent material, the preferred doping level is between ≧0.1 and ≦20%, more preferred between ≧0.5 and ≦5%.

According to a preferred embodiment of the present invention, the LED has in the colour temperature range of ≧2000 to ≦6000, preferably ≧2500 to ≦5000 K a color rendering Ra₈ of ≧80, preferably ≧85, more preferably ≧90 and most preferred ≧95 and ≦100.

By doing so, a LED with a far more better white light emittance behaviour than from known LEDs out of the prior art can be obtained.

According to a preferred embodiment of the present invention, the LED has a light efficacy of ≧10 lumen/W and ≦200 lumen/W, preferably ≧20 lumen/W and ≦150 lumen/W and most preferred ≧30 lumen/W and ≦120 lumen/W.

According to a preferred embodiment of the present invention, the light emission spectrum of the LED comprises a light emittance band in the wavelength range of ≧400 nm to ≦550 nm, preferably ≦420 nm to ≦500 nm with a maximum emission intensity of ≧2 W_{optical} to ≦30 W_{optical}, more preferably ≧5 W_{optical} to ≦30 W_{optical}, and most preferred ≧15 W_{optical} to ≦30 W_{optical}, and a full width at half maximum of ≧15 and ≦100 nm, more preferred ≧15 and ≦50 nm, yet more preferred ≧15 and ≦35 nm and most preferred of ≧15 and ≦20 nm.

According to a preferred embodiment of the present invention, the light emission spectrum of the LED comprises an emission band in the wavelength range of ≧550 nm to ≦750 nm, preferably ≧600 nm to ≦650 nm with a maximum emission intensity of ≦2 W_{optical} to ≦30 W_{optical}, more preferably ≧5 W_{optical} to ≦30 W_{optical}, and most preferred ≧15 W_{optical} to ≧30 W_{optical}, and a full width at half maximum of ≧15 and ≦100 nm, more preferred ≧15 and ≧50 nm, yet more preferred ≧15 and ≦35 nm and most preferred of ≧15 and ≦20 nm.

According to a preferred embodiment of the present invention, the LED comprises at least one red light emitting and/or conversion layer, which emits light in the wavelength of ≧550 nm to ≦750 nm, preferably ≧630 nm to ≦700 nm, and/or at least one blue light emitting layer, which emits light in the wavelength of ≧400 nm to ≦550 nm, preferably ≦420 nm to ≧500 nm, and/or at least one green and/or yellow emitting luminescence material.

According to a preferred embodiment of the present invention, the LED comprises a LED chip with a substrate, whereby the substrate is coated and/or covered with at least one red light emitting and/or conversion layer on one first surface and with at least one blue light emitting layer on the surface which is opposite the first surface. “coated and/or covered” in the sense of the present invention means in particular that on the substrate several layers may be located, one or more of which being the light emitting and/or conversion layer, whilst several other layers may serve for other purposes.

According to a preferred embodiment of the present invention, the LED chip is surrounded by and/or partly or completely covered with the at least one green and/or yellow emitting luminescent material. “Surrounded and/or partly covered” means in particular that

The LED chip is surrounded by and/or partly covered with a covering material, which comprises the at least one green and/or yellow emitting luminescent material. This covering material can be a polymer and/or a ceramic material. In case a polymer is used, preferably the polymer comprises a material chosen from the group comprising silicone polymers, PMMA, PS, PTFE, PC or mixtures thereof.

The at least one green and/or yellow emitting luminescent material is brought up on the LED chip, e.g. as a layer or a cover, which surrounds the LED chip totally or partly. This can be done in various ways. Preferably the at least one green and/or yellow emitting luminescent material is brought up by electrophoresis and/or sedimentation.

According to a preferred embodiment of the present invention, the LED comprises a LED chip with at least one red and at least one blue light emitting layer, a polymer coating located around the silicon chip and a mirror, whereby the polymer comprises at least one green and/or yellow emitting luminescent material and the mirror reflects light emitted from the LED chip.

According to a preferred embodiment of the present invention, the polymer coating comprises a material chosen from the group comprising silicone polymers, PMMA, PS, PTFE, PC or mixtures thereof.

According to a preferred embodiment of the present invention, the concentration of the luminescent material inside the polymer coating is ≧0.1 wt % to ≦50 wt %, preferably ≧1 wt % to ≦20 wt %.

According to a preferred embodiment of the present invention, ≦90% to ≧100%, preferably ≧95% nm to ≦100% of the photons emitted by the red light emitting and/or conversion layer leave the LED unabsorbed.

A LED according to the present invention can be used in a variety of systems amongst them systems being used in or as one or more of the following applications: household applications, shop lighting, home lighting, accent lighting, spot lighting, theater lighting, museum lighting, fiber-optics applications, projection systems, self-lit displays, pixelated displays, segmented displays, warning signs, medical lighting applications, indicator signs, and decorative lighting, office lighting, illumination of workplaces, automotive front lighting, and automotive interior lighting.

Furthermore, a method of preparing a LED according to the present invention is proposed, comprising the steps of: a) providing a LED chip which has a substrate, b) coating and/or covering a first surface of the substrate with at least one red light emitting and/or conversion layer; c) coating and/or covering the surface of the substrate which is opposite to the first surface with at least one blue emitting layer, whereby the steps b) and c) may also be conducted in reverse order, d) partly or totally covering and/or surrounding the LED chip with the at least one green and/or yellow emitting luminescent material, e) providing the LED chip and the polymer material in a mirror cup in such a way that the red light emitting and/or conversion layer of the LED chip is projected towards one of the mirrors of the mirror cup. It should be noted that in particular the steps b) and c) may be achieved in various ways:

One way to combine the LED chip with the conversion layer is by direct deposition of the conversion material on the substrate of the LED chip.

Another way is to remove the original substrate and replace it either with a different substrate and deposit the conversion layer on the replacement substrate or to directly mount the LED chip on the conversion layer, which might be on a support or not.

It is also envisioned, that the conversion layer itself is build or mounted in a way, that it could mechanically support the LED epitaxial (active) layer, which is in this embodiment the at least one blue emitting layer. The technologies to mount the LED active (epitaxial) layer and the conversion layer and a potential additional support layer include, van-der-Wals bonding, thermal fusing, organic or inorganic adhesion materials, wafer fusion using metals or other inorganic or organic materials, ultrasonic fusion or optically induced adhesion techniques, e.g. UV catalyzed fusion.

The aforementioned components, as well as the claimed components and the components to be used in accordance with the invention in the described embodiments, are not subject to any special exceptions with respect to their size, shape, material selection and technical concept such that the selection criteria known in the pertinent field can be applied without limitations.

Additional details, characteristics and advantages of the object of the invention are disclosed in the subclaims and the following description of the respective figures—which in an exemplary fashion—show several preferred embodiments of the LED according to the invention.

FIG. 1 shows a LED chip of a LED according to a first and second embodiment of the present invention, and

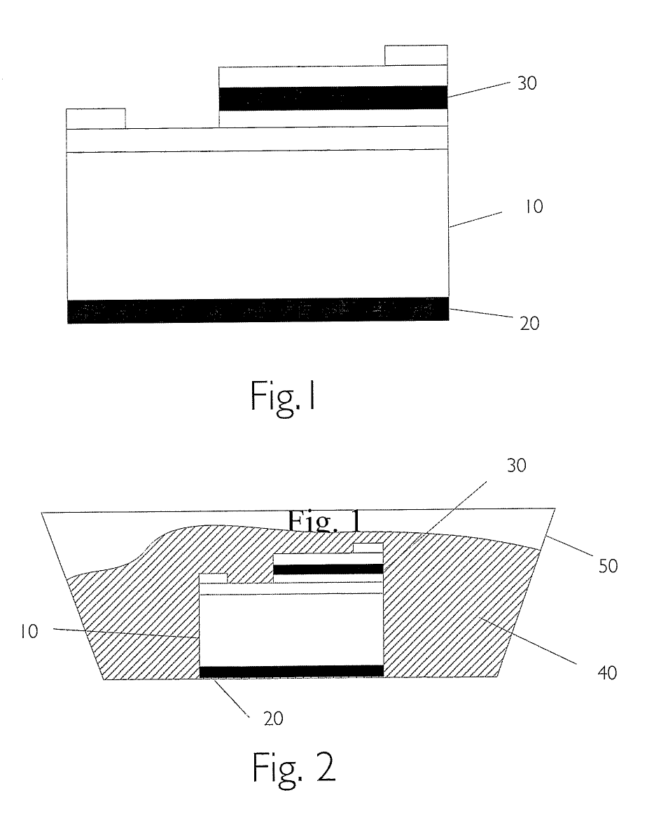

FIG. 2 shows a LED arrangement with the chip of FIG. 1.

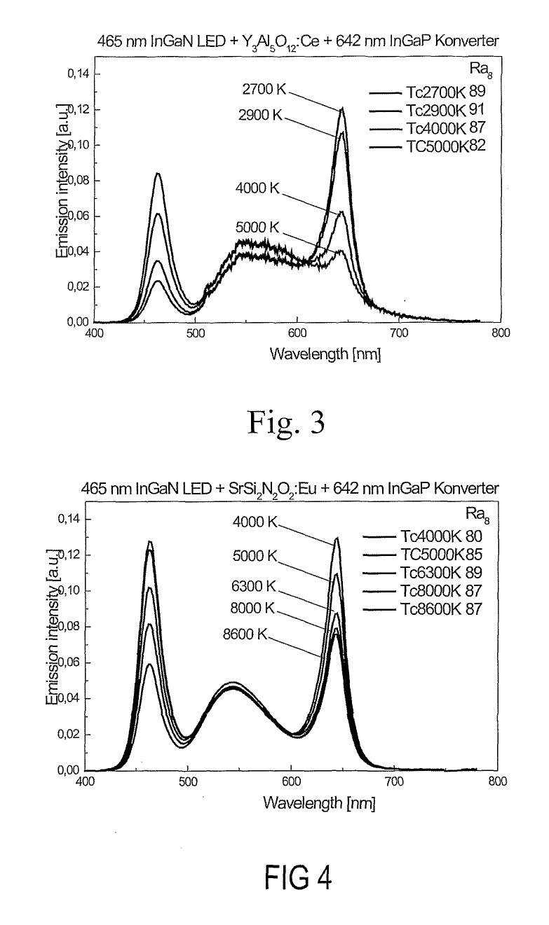

FIG. 3: Light emission spectrum of the LED according to the first embodiment of the present invention

FIG. 4: Light emission spectrum of the LED according to the first embodiment of the present invention

FIG. 1 shows a LED chip of a LED according to a first and second embodiment of the present invention. As can be seen from FIG. 1, the LED chip comprises a substrate 10 a blue light emitting layer 20 and a red light emitting and/or conversion layer 30. In the present embodiment, the substrate consists essentially out of a Al₂O₃ saphire substrate, which is essentially transparent. This allows photons emitted out of the blue light emitting layer 20 to enter the red light emitting and/or conversion layer 30, where they are converted to red light. However, also emitting layers, which emit red light “from themselves” may be used within the present invention.

FIG. 2 shows a LED arrangement with the chip of FIG. 1. As can be seen from FIG. 2, the LED comprises a polymer coating 40 around the LED chip for protection. In the present embodiment, this polymer coating consists essentially out of a silicone polymer, however, other materials such as PMMA, PS, PTFE, and/or PC or mixtures of these materials with or without silicone polymer may also be used within the present invention. The LED furthermore comprises a mirror cup 50. The mirror cup 50 and the LED chip are so located to each other that photons, which leave the LED chip towards the mirror cup 50 are reflected. In the present embodiment, the photons emitted out of the red light emitting and/or conversion layer 20 are reflected. Since the photons out of this layer have the least energy, they are not absorbed by any materials inside the LED, so that >90% the photons are able to leave the LED unabsorbed, as described above.

The polymer coating 40 furthermore comprises a green and/or yellow light emitting luminescence material. This material absorbs photons emitted from the blue light emitting layer 20 and emits photons in the green and/or yellow wavelength range, i.e. between 520 and 600 nm. The concentration of the luminescence material inside the polymer coating is between 0.1 and 50%.

According to a first embodiment of the present invention, the following materials were chosen for the red light emitting and/or conversion layer, the blue light emitting layer, and the green and/or yellow emitting luminescence material: blue light emitting layer: In_{0.2}Ga_{0.8}N, red light emitting and/or conversion layer: In_{0.45}Ga_{0.55}P, green and/or yellow emitting luminescence material: Y₃Al₅O₁₂:Ce. This LED has a emission spectrum according to FIG. 3.

It can be clearly seen that this spectrum comprises two strong bands at 465 nm and 642 nm, which have an intensity of approx. 0,08 and 0,12 (at T_{c}2700 K) respectively and a full width at half maximum of ≧15 and ≦100 nm. These bands arise from the red and blue light-emitting layer. The emittance in the wavelength range between 500 and 600 nm arises essentially out of the green and/or yellow light emitting luminescence material.

According to a second embodiment of the present invention, the following materials were chosen for the red light emitting and/or conversion layer, the blue light emitting layer, and the green and/or yellow emitting luminescence material: blue light emitting layer: In_{0.2}Ga_{0.8}N, red light emitting and/or conversion layer: In_{0.45}Ga_{0.55}P, green and/or yellow emitting luminescence material: SrSi₂N₂O₂:Eu. This LED has a emission spectrum according to FIG. 4.

It can be clearly seen that this spectrum comprises two strong bands at 465 nm and 642 nm, which have an intensity of approx. 0,13 (at T_{c} 4000 K) and a full width at half maximum of ≧15 and ≦100 nm. These bands arise from the red and blue light emitting layer. The emittance in the wavelength range between 500 and 600 nm arises essentially out of the green and/or yellow light emitting luminescence material.

Measuring methods: The Ra₈-values were measured according to the CIE 1931 procedure (ISO/CIE 10527-1991(E) Colorimetric observers).

1. A LED comprising:
at least one red light emitting and/or conversion layer, which emits light in the wavelength of ≧550 nm to ≦750 nm,
at least one blue light emitting layer, which emits light in the wavelength of ≧400 nm to ≦550 nm and
at least one green and/or yellow emitting luminescence material, which emits light in the wavelength ≧530 nm to ≦610 nm, whereby the at least one green and/or yellow emitting luminescence material is capable of absorbing light which is emitted by the at least one blue light emitting layer,
characterized in that the red light emitting and/or conversion layer is made of a semiconductor material.

2. A LED according to claim 1, whereby the at least one red light emitting and/or conversion layer, is capable of absorbing light which is emitted by the at least one blue light emitting layer.

3. A LED according to claim 1, whereby
the red light emitting and/or conversion layer is selected from a group comprising AlₓIn_{y}Ga_{z}P (x+y+z=1), AlₓGa₁₋ₓP (x≧0 and ≦1), AlₓGa₁₋ₓAs_{y}P_{1-y (x≧}0 and ≦1; y≧0 and ≦1), AlₓGa_{y} In_{z}AsᵤP₁₋ᵤ (x+y+z=1; u≧0 and ≦1) or mixtures thereof; and/or
the blue light emitting layer is selected from a group comprising AlₓIn_{y}Ga_{z}P (x+y+z=1), AlₓGa₁₋ₓP (x≧0 and ≦1), AlₓGa₁₋ₓAs_{y}P_{1-y} (x≧0 and ≦1; y≧0 and ≦1), AlₓGa_{y} In_{z}AsᵤP₁₋ᵤ (x+y+z=1; u≧0 and ≦1) or mixtures thereof; and/or
the green and/or yellow light emitting lumninescence material is selected from a group comprising BaₓSr₁₋ₓGa₂S₄:Eu (X≧0 and ≦1), BaₓSr₁₋ₓSiO₄:Eu (x≧0 and ≦1), SrSi₂N₂O₂:Eu (x≧0 and ≦1), (YₓGd₁₋ₓ)₃ (Al_{1-y}Ga_{y})₅O₁₂: Ce (x≧0 and ≦1; y≧0 and ≦1), (YₓGd₁₋ₓ)₃ (Al_{1-y}Ga_{y})₅O₁₂:Ce:Ce,Pr (x≧0 and ≦1; y≧0 and ≦1) or mixtures thereof

4. A LED according to claim 1, which has in the colour temperature range of ≧2000 to ≦6000 a color rendering Ra₈ of ≧80 and ≦100.

5. A LED according to claim 1 with a light efficacy of ≧30 lumen/W and ≦60 lumen/W, preferably ≧35 lumen/W and ≦55 lumen/W and most preferred ≧40 lumen/W and ≦50 lumen/W.

6. A LED according to claim 1 whereby
the light emission spectrum of the LED comprises a light emittance band in the wavelength range of ≧400 nm to ≦550 nm, preferably ≧420 nm to ≦500 nm with a maximum emission intensity of ≧2 W_{optical} to ≦30 W_{optical} and a full width at half maximum of ≧15 and ≦100 nm and/or
the light emission spectrum of the LED comprises a light emittance band in the wavelength range of ≧550 nm to ≦750 nm, preferably ≧630 nm to ≦700 nm with a maximum emission intensity of ≧2 W_{optical} to ≦30 W_{optical} and a full width at half maximum of ≧15 and ≦100 nm.

7. A LED according to claim 1, whereby the LED comprises a LED chip with a substrate, whereby the substrate is coated and/or covered with at least one red light emitting and/or conversion layer on one first surface and with at least one blue light emitting layer on the surface which is opposite the first surface.

8. A LED according to claim 1, whereby the LED comprises a LED chip with at least one red and at least one blue light emitting layer and whereby the LED chip is surrounded by and/or partly or completely covered with the at least one green and/or yellow emitting luminescent material.

9. A LED according to claim 1, whereby ≧90% to ≦100%, preferably ≧95% nm to ≦100% of the photons emitted by the red light emitting and/or conversion layer leave the LED unabsorbed.

10. A system comprising a LED according to claim 1, the system being used in or as one or more of the following applications:
household applications
shop lighting,
home lighting,
accent lighting,
spot lighting,
theater lighting,
museum lighting,
fiber-optics applications,
projection systems,
self-lit displays,
pixelated displays,
segmented displays,
warning signs,
medical lighting applications,
indicator signs, and
decorative lighting.
Office lighting
Illumination of workplaces
Automotive front lighting
Automotive auxiliary lighting
Automotive interior lighting

11. A method of preparing a LED according to claim 1, comprising the steps of:
a) providing a LED chip which has a substrate
b) coating and/or covering a first surface of the substrate with at least one red light emitting and/or conversion layer;
c) coating and/or covering the surface of the substrate which is opposite to the first surface with at least one blue emitting layer, whereby the steps b) and c) may also be conducted in reverse order
d) partly or totally covering and/or surrounding the LED chip with the at least one green and/or yellow emitting luminescent material.
e) providing the LED chip and the polymer material in a mirror cup in such a way that the red light emitting and/or conversion layer of the LED chip is projecting towards one of the mirrors of the mirror cup
